(19) United States
(12) Patent Application Publication
(10) Pub. No.: US 2023/0071911 A1
(43) Pub. Date: Mar. 9, 2023

(54) POWER PLUG WITH LEAKAGE CURRENT DETECTION INTERRUPTER AND ARC PROTECTION

(71) Applicant: Chengli LI, Suzhou (CN)

(72) Inventors: Chengli LI, Suzhou (CN); Xiaoming ZHANG, Suzhou (CN); Shengyun NIE, Suzhou (CN)

(73) Assignee: Chengli LI, Suzhou (CN)

(21) Appl. No.: 17/715,513

(22) Filed: Apr. 7, 2022

Related U.S. Application Data
(63) Continuation-in-part of application No. 17/472,404, filed on Sep. 10, 2021.

(30) Foreign Application Priority Data
Sep. 8, 2021 (CN) 202122163767.4
Apr. 2, 2022 (CN) 202220761465.9

(51) Int. Cl. H01R 13/53; H01R 13/713

(52) U.S. Cl. CPC H01R 13/53; H01R 13/713

(57) ABSTRACT

A power plug with leakage current detection and protection interrupter and arc protection includes: a shell, a trip assembly disposed within the shell, a cable connector electrically coupled to the trip assembly, and an arc protection shield disposed between the trip assembly and the shell. The trip assembly includes a switch having input and output contact terminals. The arc protection shield is configured to isolate the input and output contact terminals of the switch from the shell. The arc protection shield includes one or more arc blocking baffles, each disposed near corresponding input and output contact terminals, so as to isolate the contact terminals from the shell. By providing the arc protection shield between the input and output contact terminals and the shell, the shell is protected from arcs formed at the input and output contact terminals due to connection and disconnection operations. This prevents damage to the shell and improves user experience and safety.

### BACKGROUND OF THE INVENTION

### Field of the Invention

This invention relates to power circuit protection, and in particular, it relates to a power plug with leakage current detection and interruption and arc protection functions.

### Description of Related Art

With the wide use of home electrical appliances, safety becomes more and more important. Currently, many home appliances are equipped with electrical circuit protection devices, such as power plugs with leakage current detection interrupters (LCDI). Current LCDI power plugs typically have a compact mechanical structure, where the electrical contact terminals of the circuit interrupter switch are located close to the shell of the plug. During connection and disconnection operations, in particular when the power plug is connected to an electrical load, electrical arcs may form at the contact terminals of the circuit interrupter switch. The shell of the plug may be susceptible to damage by frequent electrical arcs, and sometimes the flash of the arc may even be visible to the user through the shell, adversely affecting user experience. When damage to the shell occurs, electrical shock or fire may occur.

### SUMMARY

To solve these problems, the present invention provides a power plug with leakage current detection and protection interrupter and arc protection, which includes: a shell; a trip assembly disposed within the shell, which includes a switch; a cable connector, electrically coupled to the trip assembly; and an arc protection shield disposed between the trip assembly and the shell, configured to isolate input and output contact terminals of the switch from the shell; wherein the arc protection shield includes one or more arc blocking baffles, each disposed between the input and output contact terminals and the shell, so as to isolate the contact terminals from the shell.

In some embodiments, the arc protection shield further includes a body, wherein each of the arc blocking baffles is joined to a corresponding side of the body at an angle.

In some embodiments, the arc blocking baffles are formed of a high temperature resistant and arc resistant material.

In some embodiments, the arc protection shield is formed integrally of a high temperature resistant and arc resistant material.

In some embodiments, the arc protection shield is disposed along an inner wall of the shell.

In some embodiments, the arc protection shield further includes a plurality of openings through which a plurality of plug prongs of the power plug pass.

In some embodiments, the arc protection shield further includes another opening through which a reset button of the trip assembly pass.

In embodiments of the present invention, by providing an arc protection shield between the input and output electrical contact terminals of the trip assembly and the shell, the shell is protected from arcs formed at the input and output contact terminals due to connection and disconnection operations. This prevents damage to the shell and improves user experience and safety.

### BRIEF DESCRIPTION OF THE DRAWINGS

Preferred embodiments of the present invention are described with reference to the drawings. These drawings serve to explain the embodiments and their operating principle, and only illustrate structures that are necessary to the understanding of the principles of the invention. These drawings are not necessarily to scale. In the drawings, like features are designated by like reference symbols.

FIGS. 1a and 1b are exterior perspective views of a power plug with LCDI and arc protection according to an embodiment of the present invention.

FIG. 2 is an exploded view of interior structures of the power plug of FIG. 1.

FIG. 3 is an exploded view showing the assembly of the arc protection shield and the trip assembly of the power plug of FIG. 1.

### DETAILED DESCRIPTION OF PREFERRED EMBODIMENTS

Preferred embodiments of the present invention are described below with reference to the drawings. These drawings and descriptions explain embodiments of the invention but do not limit the invention. The described embodiments are not all possible embodiments of the present invention. Other embodiments are possible without departing from the spirit and scope of the invention, and the structure and/or logic of the illustrated embodiments may be modified. Thus, it is intended that the scope of the invention is defined by the appended claims.

Before describing the embodiments, some terms used in this disclosure are defined here to help the reader better understand this disclosure.

In this disclosure, terms such as “connect”, “couple”, “link” etc. should be understood broadly, without limitation to physical connection or mechanical connection, but can include electrical connection, and can include direct or indirection connections. Terms such as “a” and “one” do not limit the quantity, and refers to “at least one”.

In the descriptions below, terms such as “including” are intended to be open-ended and mean “including without limitation”, and can include other contents. “Based on” means “at least partly based on.” “An embodiment” means “at least one embodiment.” “Another embodiment” means “at least another embodiment,” etc.

The technical problems solved by embodiments of the present invention include: to improve safety of the LCDI power plug, to prevent damage caused by electrical arcs and resulting electrical shock or fire.

To solve the above problems, the present invention provides a power plug with leakage current detection and protection interrupter and arc protection, which includes: a shell; a trip assembly disposed within the shell; a cable connector, electrically coupled to the trip assembly; and an arc protection shield disposed between the trip assembly and the shell. The trip assembly includes a switch having input and output contact terminals. The arc protection shield is configured to isolate the input and output contact terminals of the switch from the shell. The arc protection shield includes one or more arc blocking baffles, each disposed near corresponding input and output contact terminals, so as to isolate the contact terminals from the shell.

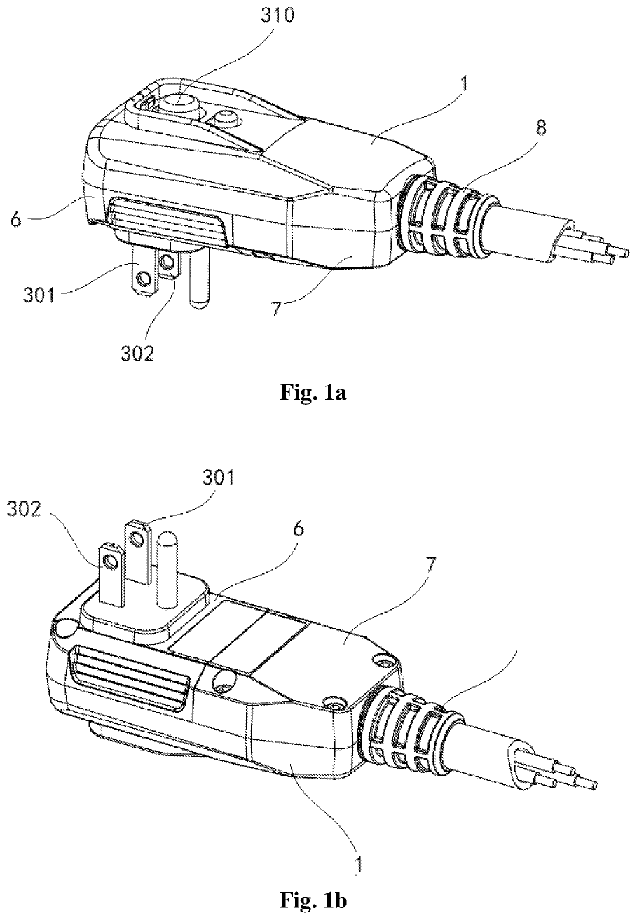

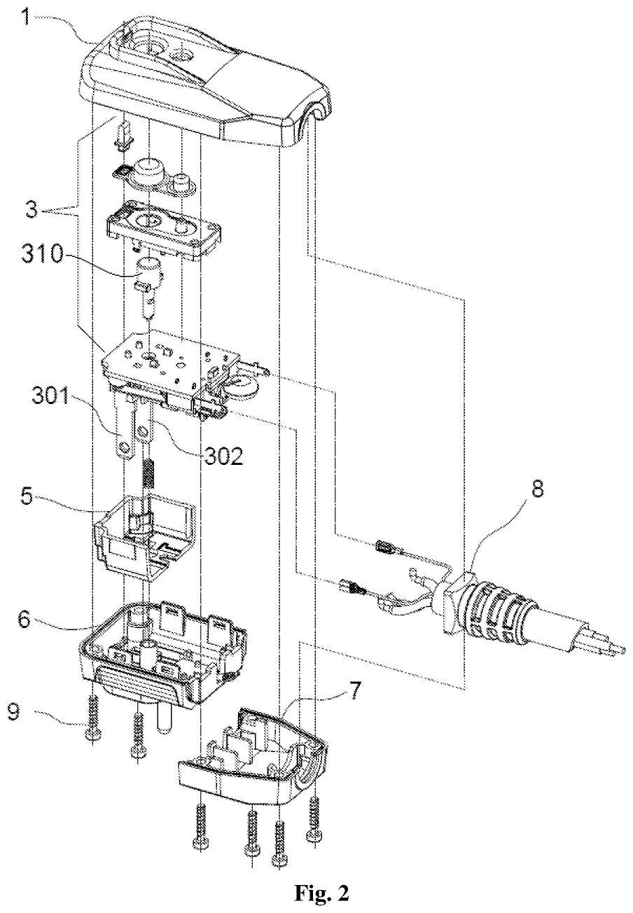

FIGS. 1a, 1b and 2 illustrate an LCDI power plug according to an embodiment of the present invention. FIGS. 1a and 1b are respectively top and bottom perspective views of the exterior of the power plug, and FIG. 2 is an exploded view of interior structures of the power plug. As shown in FIGS. 1a, 1b and 2, the LCDI power plug includes an upper cover 1 of the shell, a trip assembly 3, a cable connector 8, a bottom cover 6 of the shell, a rear cover 7 of the shell, and an arc protection shield 5 disposed between the trip assembly 3 and the shell. In the illustrated embodiment, the upper cover 1, bottom cover 6 and rear cover 7 of the shell are affixed to each other by fasteners such as screws 9. The bottom cover 6 and rear cover 7 may alternatively be formed integrally to constitute a bottom cover of the shell. The bottom cover 6 includes openings through which the plug prongs, including a neutral (N) prong 301, a hot (L) prong 302, and a ground prong, extend from the interior to the exterior of the shell. The cable connector 8 includes conductors electrically coupled to output contact terminals of the trip assembly.

According to embodiments of the present invention, advantageously, the arc protection shield 5 is provided between the trip assembly 3 and the shell. The trip assembly 3 includes a coil, a leakage current detection circuit, a drive mechanism, a switch, and a reset button 310. More specifically, the coil, leakage current detection circuit, and drive mechanism are configured to drive the switch, causing the input contact terminals and output contact terminals of the switch to be closed or open, thereby connecting or disconnecting the electrical power supply.

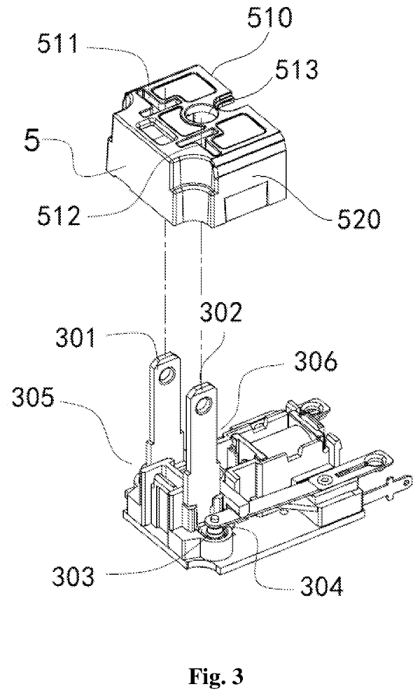

As shown in FIG. 3, the input and output contact terminals of the switch include L line input contact terminal 303 and output contact terminal 304, and N line input contact terminal 305 and output contact terminal 306. The arc protection shield 5, which is a separate piece from the shell, is configured to isolate the contact terminals 303, 304, 305 and 306 from the shell.

More specifically, referring to FIGS. 2 and 3, in the illustrated embodiment, the arc protection shield 5 includes a body 510 and at least two arc blocking baffles 520, which are disposed symmetrically on two sides of the body 510, each joined to the corresponding side of the body at an angle. One of the arc blocking baffles 520 is disposed near the L line input contact terminal 303 and output contact terminal 304, and another one (not shown in the drawings) is disposed near the N line input contact terminal 305 and output contact terminal 306. Thus, both pairs of contact terminals are isolated from the shell.

The arc blocking baffles 520 are formed of high temperature resistant and arc resistant materials, while the body 510 may be formed of other electrical insulating materials. When the coil, leakage current detection circuit, and drive mechanism of the trip assembly 3 cooperate to drive the switch to disconnect the two pairs of contact terminals, electrical arcs may occur between the terminals. In the power plug of the present embodiments, the arc protection shield 5 can cover the trip assembly 3, and the arc blocking baffles 520 can isolate the arcs from the shell. This prevents damage to the shell by the arcs, and/or prevents flashes from the arcs being visible to the user through the shell, thereby improving safety and enhancing user experience.

As shown in FIG. 3, the arc protection shield 5 further includes openings 511 and 512, through which the neutral (N) prong 301, hot (L) prong 302, and a ground prong of the trip assembly 3 pass, as well as an opening 513 through which the reset button 310 pass (the reset button 310 is exposed to the exterior of the plug and accessible by the user).

In preferred embodiments, the arc protection shield 5 is disposed along the inner wall of the shell, and has sufficient thicknesses, such that at least the material characteristics and thicknesses of the arc blocking baffles 520 can be relied on to prevent arcs from damaging the shell. The thicknesses of the arc blocking baffles 520 may also depend on the size of the shell and the trip assembly.

In other embodiments, the body 510 and arc blocking baffles 520 of the arc protection shield 5 may be formed as one piece from a high temperature resistant and arc resistant material.

The LCDI power plug according to embodiments of the present invention has the advantages of simple electrical structure, low cost, easy installation, etc. In practice, the shape and size of the arc protection shield can be adapted based on the structure of the power plug, so it can be widely used.

It will be apparent to those skilled in the art that various modification and variations can be made in the embodiments of the present invention without departing from the spirit or scope of the invention. Thus, it is intended that the present invention cover modifications and variations that come within the scope of the appended claims and their equivalents.

What is claimed is:

1. A power plug with leakage current detection and protection interrupter and arc protection, comprising:
a shell;
a trip assembly, disposed within the shell, and including a switch, the switch including a plurality of input contact terminals and output contact terminals;
a cable connector, electrically coupled to the trip assembly; and
an arc protection shield, disposed between the trip assembly and the shell, configured to isolate the input contact terminals and output contact terminals of the switch from the shell;
wherein the arc protection shield includes one or more arc blocking baffles, each disposed between the input contact terminals and output contact terminals and the shell.

2. The power plug of claim 1, wherein the arc protection shield further includes a body, wherein each of the arc blocking baffles is joined to a corresponding side of the body at an angle.

3. The power plug of claim 1, wherein the arc blocking baffles are formed of a high temperature resistant and arc resistant material.

4. The power plug of claim 2, wherein the arc protection shield is formed as one piece of a high temperature resistant and arc resistant material.

5. The power plug of claim 1, wherein the arc protection shield is disposed along an inner wall of the shell.

6. The power plug of claim 1, further comprising a plurality of plug prongs extending from an interior of the shell to an exterior of the shell, wherein the arc protection shield further includes a plurality of openings through which the plurality of plug prongs pass.

7. The power plug of claim 6, further comprising a reset button exposed to the exterior of the shell, wherein the arc protection shield further includes another opening through which the reset button pass.
